(19) United States
(12) Patent Application Publication
(10) Pub. No.: US 2004/0257599 A1
(43) Pub. Date: Dec. 23, 2004

(54) Color-correcting device and method for image forming apparatus

(75) Inventors: Tsai Hung Chi, Taoyuan (TW); Tsai Chao Lien, Taoyuan (TW); Ying Hao Hsu, Taoyuan (TW)

Correspondence Address: Richard P. Berg, Esq., c/o LADAS & PARRY, Suite 2100, 5670 Wilshire Boulevard, Los Angeles, CA, 90036-5679, US

(73) Assignee: BENQ CORPORATION

(21) Appl. No.: 10/844,126

(22) Filed: May 11, 2004

(30) Foreign Application Priority Data
Jun. 19, 2003 (TW) 092116697

(51) Int. Cl. H04N 1/56; H04N 1/60

(52) U.S. Cl. 358/1.9; 358/518; 358/504; 358/523

(57) ABSTRACT

The invention provides a color-correcting device and method for correcting the colors, by use of a well-calibrated first image forming apparatus, sensed by a second image forming apparatus identical to said first image forming apparatus. A first image, associated with a standard color card, is previously captured by the first image forming apparatus under a standard environment. The color-correcting device and method of the invention first captures a second image associated with the standard color card by the second image forming apparatus under the standard environment, and then, based on the first image and the second image, generates a color correction matrix in the second image forming apparatus. When the second image forming apparatus is turned on , the color correction matrix is loaded, and the colors sensed by the second image forming apparatus are corrected in accordance with the color correction matrix.

### BACKGROUND OF THE INVENTION

1. Field of the Invention

The present invention relates to a color-correcting device of an image forming apparatus and method thereof; more particularly, the present invention relates to the color-correcting device and method used in the manufacturing procedure of the image forming apparatus.

2. Description of the Prior Art

Conventional image forming apparatuses, such as digital cameras, digital video cameras . . . etc., all comprise photo-sensing units for sensing and measuring the light input from the outside of the image forming apparatus to form an image in the image forming apparatus. The photo-sensing units consist of electronic and mechanical components; because of the property difference of each component, the photo-sensing properties of every photo-sensing unit have some differences among each other. The primary colors (Red, Green, and Blue lights) are used to analyze the photo-sensing properties of the photo-sensing units, some units have weaker ability to sense red light, and some have weaker ability to sense green light. Therefore, two images of the same scene captured by two different image forming apparatuses of the same model under the same environment may have a slight color difference. Therefore, color-correction must be applied to every image forming apparatus during manufacture.

### SUMMARY OF THE INVENTION

The objective of the invention is to provide a color-correcting device of an image forming apparatus and method thereof; the color-correcting device and method of the image forming apparatus is used for applying the color correction to the image forming apparatus during manufacture, so as to make the image forming apparatuses in the same manufacturing procedure have identical color expression.

According to the present invention, the color-correcting device corrects by using a well-calibrated first image forming apparatus to adjust colors sensed by a second image forming apparatus. The two image forming apparatuses are identical, and the color-correcting device is equipped in the second image forming apparatus. A first image associated with a standard color card is captured by the first image forming apparatus under a standard environment. The standard color card comprises N number of standard color blocks, and each of the N standard color blocks of the first image comprises M number of first color values respectively, with M and N being natural numbers. The color-correcting device comprises a receiving module, a first matrix generating module, an image capturing module, a second matrix generating module, a data processing module, a storing module, and a color-correcting module. The receiving module is used for receiving the first image transmitted from the first image forming apparatus. The first matrix generating module is used for generating M number of N×1 first matrixes (Di) according to the first image; each of the M first matrixes is formed by the ith color values of the N standard color blocks of the first image respectively, wherein i is an integer index within the range from 1 to M. The image capturing module is used for capturing a second image associated with the standard color card under the standard environment; each of the N standard color blocks of the second image comprises M number of second color values respectively. The second matrix generating module is used for generating an N×M (A) second matrix; the second matrix is formed by M number of second color values of N number of standard color blocks of the second image. The data processing module is used for calculating an M×M color correction matrix (θ), based on M number of first matrixes and second matrix. The storing module is used for storing the color correction matrix. The color-correcting module is used for accessing the color correction matrix from the storing module when the second image forming apparatus is turned on; it then corrects the colors sensed by the second image forming apparatus according to the color correction matrix.

The advantage and spirit of the invention may be understood by the following recitations together with the appended drawings.

### BRIEF DESCRIPTION OF THE APPENDED DRAWINGS

FIG. 1 is a schematic diagram of the color-correcting device of the image forming apparatus according to the present invention.

FIG. 2 is a schematic diagram of the standard color card of the color-correcting device according to the present invention.

FIG. 3 is a schematic diagram of the color-correcting device of the image forming apparatus according to another embodiment of the present invention.

FIG. 4 is a flow chart of the color-correcting method of the image forming apparatus according to the present invention.

FIG. 5 is a generating flow chart of the color correction matrix of the color-correcting method of the image forming apparatus shown in FIG. 4.

### DETAILED DESCRIPTION OF THE INVENTION

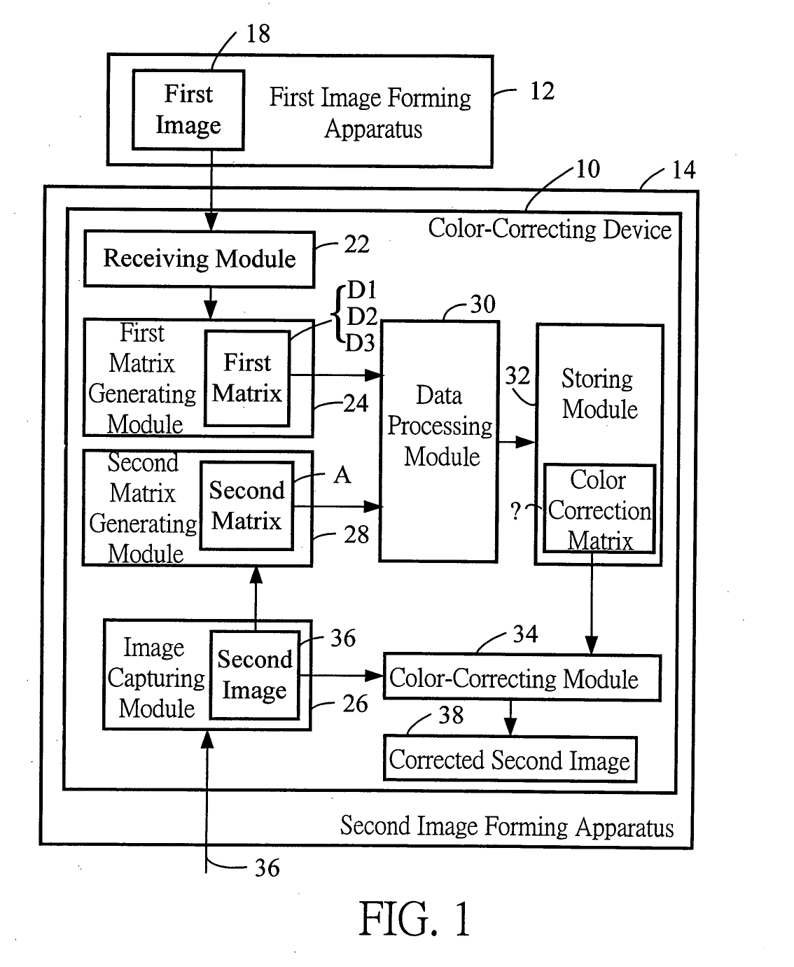

Referring to FIG. 1, FIG. 1 is a schematic diagram of the color-correcting device 10 of the image forming apparatus according to the present invention. The color-correcting device 10 uses a well-calibrated first image forming apparatus 12 to correct the colors sensed by a second image forming apparatus 14. The second image forming apparatus is identical to the first image forming apparatus, and the color-correcting device 10 is equipped in the second image forming apparatus 14. The color-correcting device 10 comprises a receiving module 22, a first matrix generating module 24, an image capturing module 26, a second matrix generating module 28, a data processing module 30, a storing module 32, and a color-correcting module 34.

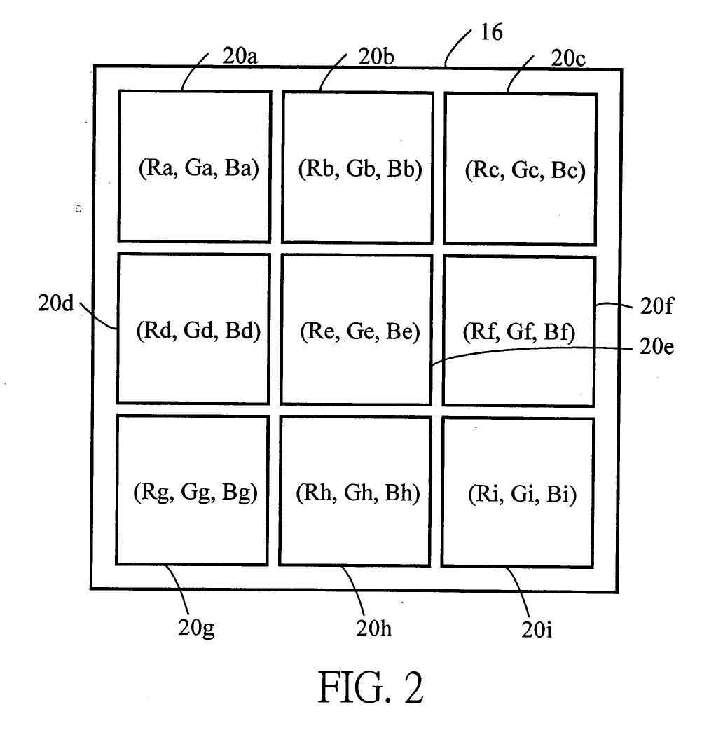

Referring to FIG. 1 and FIG. 2, FIG. 2 is a schematic diagram of the standard color card 16 of the color-correcting device 10 according to the present invention. A first image 18 associated with a standard color card 16 is captured by the first image forming apparatus 12 under a standard environment. The standard color card 16 comprises 9 standard color blocks (20a, 20b, 20c, 20d, 20e, 20f, 20g, 20h, and 20i); each of the 9 standard color blocks (20a, 20b, 20c, 20d, 20e, 20f, 20g, 20h, and 20i) of the first image 18 comprises 3 individual first color values (R, G, and B) respectively. The first color values (R, G, and B) of the standard color block (20a) are represented as (Ra,Ga,Ba), and the first color values (R, G, and B) of the standard color block (20b) are represented as (Rb,Gb,Bb); the others are analogized as (Rc,Gc,Bc), (Rd,Gd,Bd), (Re,Ge,Be), (Rf,Gf,Bf), (Rg,Gg,Bg), (Rh,Gh,Bh), and (Ri,Gi,Bi).

The receiving module 22 is used for receiving the first image 18 transmitted from the first image forming apparatus 12.

The first matrix generating module 24 is used for generating three 9×1 first matrixes (D1, D2, and D3) according to the first image 18; each of the three first matrixes (D1, D2, and D3) is respectively formed by the first color values (R, G, and B) of the 9 standard color blocks (20a, 20b, 20c, 20d, 20e, 20f, 20g, 20h, and 20i) of the first image 18.

$$D1 = [ \begin{matrix}Ra \\ Rb \\ Rc \\ Rd \\ Re \\ Rf \\ Rg \\ Rh \\ Ri\end{matrix} ] ; D2 = [ \begin{matrix}Ga \\ Gb \\ Gc \\ Gd \\ Ge \\ Gf \\ Gg \\ Gh \\ Gi\end{matrix} ] ; D3 = [ \begin{matrix}Ba \\ Bb \\ Bc \\ Bd \\ Be \\ Bf \\ Bg \\ Bh \\ Bi\end{matrix} ]$$

The image capturing module 26 is used for capturing a second image 36 associated with the standard color card 16 under the standard environment; each of the 9 standard color blocks (20a′, 20b′, 20c′, 20d′, 20e′, 20f′, 20g′, 20h′, and 20i′) of the second image 36 comprises 3 individual second color values (R′, G′, and B′) respectively. The second color values (R′, G′, and B′) of the standard color block (20a′) are represented as (R′a,G′a,B′a), and the second color values (R′, G′, and B′) of the standard color block (20b′) are represented as (R′b,G′b,B′b); the others are analogized correspondingly as (R′c,G′c,B′c), (R′d,G′d,B′d), (R′e,G′e,B′e), (R′f,G′f,B′f), (R′g,G′g,B′g), (R′h,G′h,B′h), and (R′i,G′i,B′i). The second matrix generating module 28 is used for generating a 9×3 second matrix A according to the second image 36; the second matrix (A) consists of the second color values (R′, G′, and B′) of the 9 standard color blocks (20a′, 20b′, 20c′, 20d′, 20e′, 20f′, 20g′, 20h′, and 20i′) of the second image 36 respectively.

$$A = [ \begin{matrix}{R}^{′} a & {G}^{′} a & {B}^{′} a \\ {R}^{′} b & {G}^{′} b & {B}^{′} b \\ {R}^{′} c & {G}^{′} c & {B}^{′} c \\ {R}^{′} d & {G}^{′} d & {B}^{′} d \\ {R}^{′} e & {G}^{′} e & {B}^{′} e \\ {R}^{′} f & {G}^{′} f & {B}^{′} f \\ {R}^{′} g & {G}^{′} g & {B}^{′} g \\ {R}^{′} h & {G}^{′} h & {B}^{′} h \\ {R}^{′} i & {G}^{′} i & {B}^{′} i\end{matrix} ]$$

The data processing module 30 is used for calculating a 3×3 color correction matrix (θ), based on the 3 first matrixes (D1, D2, and D3) and the second matrix (A). The storing module 32 is used for storing the color correction matrix (θ).

$$θ = [ \begin{matrix}{a}_{11} & {a}_{12} & {a}_{13} \\ {a}_{21} & {a}_{22} & {a}_{23} \\ {a}_{31} & {a}_{32} & {a}_{33}\end{matrix} ]$$

When the second image forming apparatus is turned on, the color-correcting module 34 accesses the color correction matrix (θ) from the storing module 32 and corrects the colors sensed by the second image forming apparatus 14 in accordance with the color correction matrix (θ).

In other words, the color correction matrix (θ) consists of three 3×1 matrixes (θ1, θ2, and θ3).

$$θ 1 = [ \begin{matrix}{a}_{11} \\ {a}_{12} \\ {a}_{13}\end{matrix} ] ; θ 2 = [ \begin{matrix}{a}_{21} \\ {a}_{22} \\ {a}_{23}\end{matrix} ] ; θ 3 = [ \begin{matrix}{a}_{31} \\ {a}_{32} \\ {a}_{33}\end{matrix} ]$$

The data processing module 30 calculates each element of the color correction matrix (θ) by the following formula and stores the calculated color correction matrix (θ) in the storing module 32.

∂(D1−A·θ1)²=0;

∂(D2−A·θ2)²=0;

∂(D3−A·θ3)²=0.

Therefore, when the second image forming apparatus 14 is turned on, the color-correcting module 34 accesses the color correction matrix (θ) from the storing module 32. Then, the color-correcting module 34 forms a 3×1 second color value matrix (Z) from the second color values (R′, G′, and B′) of the second image 36 sensed by the second image forming apparatus 14; the color correction matrix (θ) multiplies the second color value matrix (Z) to obtain the corrected row matrix (X) of the second color values which consist of the corrected second color values (R″, G″, and B″) of the corrected second image 38.

$$Z = [ \begin{matrix}{R}^{′} \\ {G}^{′} \\ {B}^{′}\end{matrix} ] ; X = [ \begin{matrix}{R}^{″} \\ {G}^{″} \\ {B}^{″}\end{matrix} ]$$

X=θ×Z

From the above descriptions, the color-correcting device 10 of the image forming apparatus of the present invention can generate a color correction matrix (θ) in the image forming apparatus and automatically correct the colors of the image forming apparatus, so the images of the same scene captured by the image forming apparatuses of the same model under the same environment can have the same color expression.

Besides, in the above-mentioned embodiment, the first color values (R, G, and B) and the second color values (R′, G′, and B′) both comprise the 3 basic colors of the red (R and R′), the green (G and G′), and the blue (B and B′). Therefore, by the conventional converting rule (such as the following formula), the first color values (R, G, and B) and the second color values (R′, G′, and B′), which comprise the 3 basic colors of the red (R and R′), the green (G and G′), and the blue (B and B′), are converted to the third color values (Y, Cr, and Cb) and the fourth color values (Y′, Cr′, and Cb′), which comprise the 3 basic color expression of brightness (Y and Y′), red color difference (Cr and Cr′), and green color difference (Cb and Cb′).

$$[ \begin{matrix}Y \\ Cr \\ Cb\end{matrix} ] = [ \begin{matrix}0.299 & 0.587 & 0.114 \\ - 0.168 & - 0.331 & 0.5 \\ 0.5 & - 0.418 & - 0.081\end{matrix} ] [ \begin{matrix}R \\ G \\ B\end{matrix} ]$$

From the above-mentioned conversion, the first matrix generating module 24 and the second matrix generating module 28 of the color-correcting device 10 of the image forming apparatus of the present invention generate the first matrixes (D1′, D2′, and D3′) and the second matrix (A) that respectively corresponds to the 3 basic color expression of brightness (Y), red color difference (Cr), and green color difference (Cb).

$$\begin{matrix}{D1}^{′} = [ \begin{matrix}Ya \\ Yb \\ Yc \\ Yd \\ Ye \\ Yf \\ Yg \\ Yh \\ Yi\end{matrix} ] ; {D2}^{′} = [ \begin{matrix}Cra \\ Crb \\ Crc \\ Crd \\ Cre \\ Crf \\ Crg \\ Crh \\ Cri\end{matrix} ] ; {D3}^{′} = [ \begin{matrix}Cba \\ Cbb \\ Cbc \\ Cbd \\ Cbe \\ Cbf \\ Cbg \\ Cbh \\ Cbi\end{matrix} ] \\ {A}^{′} = [ \begin{matrix}{Y}^{′} a & {Cr}^{′} a & {Cb}^{′} a \\ {Y}^{′} b & {Cr}^{′} b & {Cb}^{′} b \\ {Y}^{′} c & {Cr}^{′} c & {Cb}^{′} c \\ {Y}^{′} d & {Cr}^{′} d & {Cb}^{′} d \\ {Y}^{′} e & {Cr}^{′} e & {Cb}^{′} e \\ {Y}^{′} f & {Cr}^{′} f & {Cb}^{′} f \\ {Y}^{′} g & {Cr}^{′} g & {Cb}^{′} g \\ {Y}^{′} h & {Cr}^{′} h & {Cb}^{′} h \\ {Y}^{′} i & {Cr}^{′} i & {Cb}^{′} i\end{matrix} ]\end{matrix}$$

The data processing module 30 is used for calculating a 3×3 color correction matrix (θ), based on the 3 first matrixes (D1′, D2′, and D3′) and the second matrix (A′).

By the color correction matrix (θ), the color-correcting device 10 of the image forming apparatus of the present invention generates a color correction matrix (θ) in the image forming apparatus to be the reference values to automatically adjust the white balance of the image forming apparatus; this allows the image forming apparatuses of the same model have the same white balance expression.

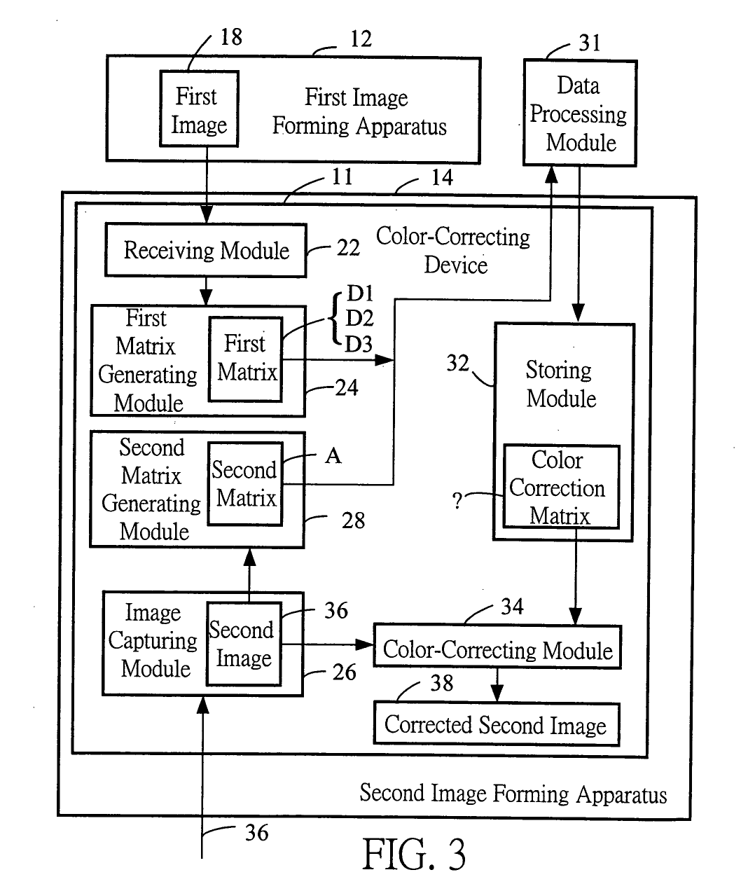

Referring to FIG. 3, FIG. 3 is a schematic diagram of the color-correcting device 11 of the image forming apparatus according to another embodiment of the present invention. Compared to the color-correcting device 10 shown in FIG. 1, the data processing module 31 is configured on the outside of the second image forming apparatus 14. In other words, the second image forming apparatus 14 transmits the first matrixes (D1, D2, and D3) and the second matrix (A) to a data processing module 31 configured outside the second image forming apparatus 14 for calculating the color correction matrix (θ); it then transmits the color correction matrix (θ) back to the storing module 32 of the second image forming apparatus 14 for storing the color correction matrix (θ).

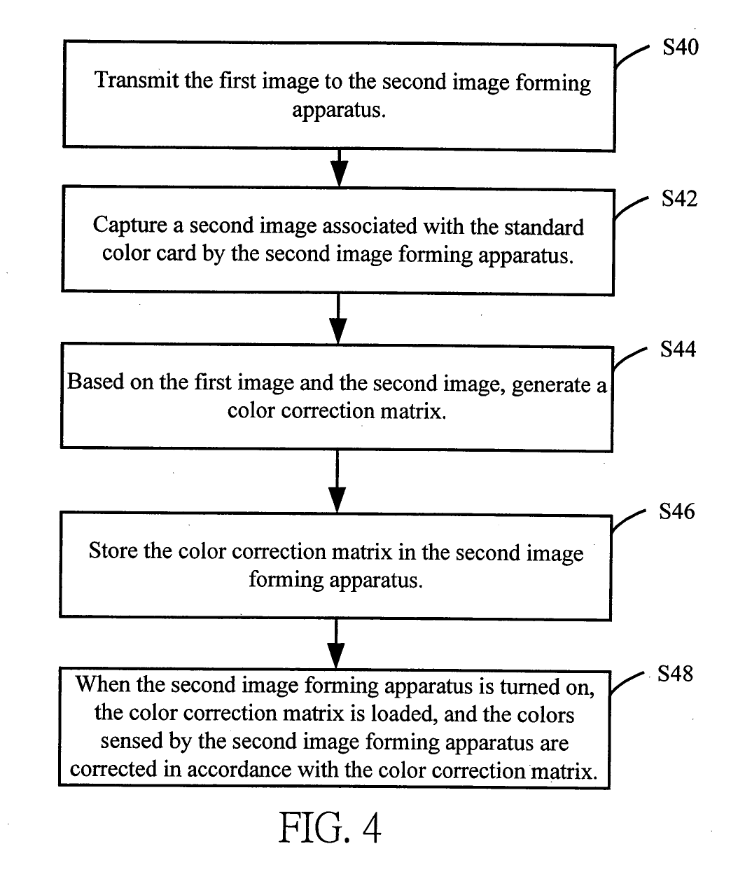

Referring to FIG. 4, FIG. 4 is a flow chart of the color-correcting method of the image forming apparatus according to the present invention. The following paragraphs are the detailed description of the color-correcting method applied in the image forming apparatus of the present invention shown in FIG. 1. The color-correcting method of the image forming apparatus comprises the following steps:

Step S40: transmit the first image 18 from the first image forming apparatus 12 to the second image forming apparatus 14.

Step S42: capture a second image 36 associated with the standard color card 16 by the second image forming apparatus 14 under the standard environment.

Step S44: based on the first image 18 and the second image 36, generate a color correction matrix (θ) in the second image forming apparatus 14.

Step S46: store the color correction matrix (0) in the second image forming apparatus 14.

Step S48: when the second image forming apparatus 14 is turned on, the color correction matrix (θ) is loaded, and the colors sensed by the second image forming apparatus 14 are corrected in accordance with the color correction matrix (θ).

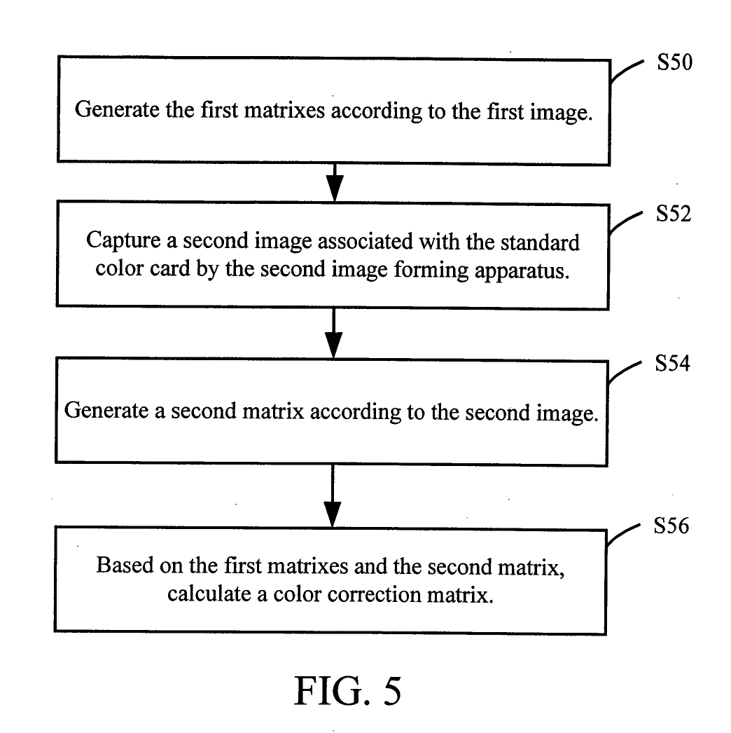

Referring to FIG. 5, FIG. 5 is a generating flow chart of the color correction matrix (θ) of the color-correcting method of the image forming apparatus shown in FIG. 4. The following paragraphs are the detailed description of the generating method of the color correction matrix (θ) applied in the color-correcting method shown in FIG. 4.

Step S50: generate, according to the first image 18, three 9×1 first matrixes (D1, D2, and D3); each of the 3 first matrixes (D1, D2, and D3) is formed by the first color values (R, G, and B) of the 9 standard color blocks (20a, 20b, 20c, 20d, 20e, 20f, 20g, 20h, and 20i) of the first image respectively.

Step S52: capture a second image 36 associated with the standard color card 16 by the second image forming apparatus 14 under the standard environment; each of the 9 standard color blocks (20a′, 20b′, 20c′, 20d′, 20e′, 20f′, 20g′, 20h′, and 20i′) of the second image 36 comprises 3 individual second color values (R′, G′, and B′) respectively.

Step S54: generate, according to the second image 36, a 9×3 second matrix (A); the second matrix is formed by the 3 second color values (R′, G′, and B′) of the 9 standard color blocks (20a′, 20b′, 20c′, 20d′, 20e′, 20f′, 20g′, 20h′, and 20i′) of the second image 36.

Step S56: based on the 3 first matrixes (D1, D2, and D3) and the second matrix (A), calculate a 3×3 color correction matrix (θ).

From the above descriptions, the color-correcting method of the image forming apparatus of the present invention generates a color correction matrix (θ) in the image forming apparatus and automatically corrects the colors of the image forming apparatus; this allows the images of the same scene captured by the image forming apparatuses of the same model under the same environment have the same color expression.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the meters and bounds of the appended claims.

1. A color-correcting device for correcting, by use of a well-calibrated first image forming apparatus, colors sensed by a second image forming apparatus, with the color-correcting device being equipped in the second image forming apparatus, a first image associated with a standard color card being captured by the first image forming apparatus under a standard environment, the standard color card comprising N standard color blocks, each of the N standard color blocks of the first image comprising M first color values respectively, N and M being natural numbers respectively, the color-correcting device comprising:
a receiving module for receiving the first image transmitted from the first image forming apparatus;
a first matrix generating module for generating M number of N×1 first matrixes (Di), each of the M first matrixes consisting of ith color values of the N standard color blocks of the first image respectively, wherein i is an integer index ranging from 1 to M;
an image capturing module for capturing a second image associated with the standard color card at the standard environment, each of the N standard color blocks of the second image comprising M number of second color values respectively;
a second matrix generating module for generating an N×M second matrix (A), the second matrix consisting of M second color values of N standard color blocks of the second image;
a data processing module, based on the M first matrixes and the second matrix, for calculating a M×M color correction matrix (θ);
a storing module for storing the color correction matrix; and
a color-correcting module for accessing the color correction matrix from the storing module and correcting the colors sensed by the second image forming apparatus in accordance with the color correction matrix when the second image forming apparatus is turned on.

2. The color-correcting device of claim 1, wherein the color correction matrix (θ) consists of M row matrixes (θi) and is calculated by the following formula:
∂(Dᵢ−A·θᵢ)²=0

3. The color-correcting device of claim 1, wherein all of the M first color values and the M second color values comprise R, G, and B (Red, Green, and Blue) values.

4. The color-correcting device of claim 1, wherein all of the M first color values and the M second color values comprise Y (Brightness) value.

5. The color-correcting device of claim 1, wherein the color correction matrix (θ) is a 3×3 matrix.

6. The color-correcting device of claim 1, wherein the second Image forming apparatus is identical to the first image forming apparatus.

7. A color-correcting method for correcting, by using a well-calibrated first image forming apparatus, colors sensed by a second image forming apparatus, a first image associated with a standard color card being captured by the first image forming apparatus at a standard environment, said method comprising the following steps of:
transmitting the first image from the first image forming apparatus to the second image forming apparatus;
capturing a second image associated with the standard color card by the second image forming apparatus under the standard environment;
based on the first image and the second image, generating a color correction matrix (θ) in the second image forming apparatus; and
storing the color correction matrix in the second image forming apparatus;
wherein when the second image forming apparatus is turned on, the color correction matrix is loaded, and the colors sensed by the second image forming apparatus are corrected in accordance with the color correction matrix.

8. The color-correcting method of claim 7, wherein the standard color card comprises N standard color blocks, each of the N standard color blocks of the first image comprises M number of first color values respectively, N and M are natural numbers respectively, the color correction matrix (θ) is generated by the following steps of:
generating, according to the first image, M number of N×1 first matrixes (Di), each of the M first matrixes consisting of ith first color values of the N standard color blocks of the first image respectively, wherein i is an integer index raging from 1 to M;
capturing a second image associated with the standard color card by the second image forming apparatus under the standard environment, each of the N standard color blocks of the second image comprising M second color values respectively;
generating, according to the second image, an N×M second matrix (A), the second matrix consisting of the M second color values of the N standard color blocks of the second image; and
calculating the M×M color correction matrix (θ) based on the M first matrixes and the second matrix.

9. The color-correcting method of claim 8, wherein the color correction matrix (θ) consists of M row matrixes (θi), and is calculated by the following formula:
∂(Dᵢ−A·θᵢ)²=0

10. The color-correcting method of claim 8, wherein all of the M first color values and the M second color values comprise R, G, and B (Red, Green, and Blue) values.

11. The color-correcting method of claim 8, all of the M first color values and the M second color values comprising Y (Brightness) value.

12. The color-correcting method of claim 8, wherein the color correction matrix (θ) is a 3×3 matrix.

13. The color-correcting method of claim 8, wherein the second image forming apparatus is identical to the first image forming apparatus.
